(19) United States
(12) Patent Application Publication
(10) Pub. No.: US 2025/0099905 A1
(43) Pub. Date: Mar. 27, 2025

(54) PROCESSES AND APPARATUSES FOR SPECIES ADSORPTION AND ADSORBENT REGENERATION

(71) Applicant: UOP LLC, Des Plaines, IL (US)

(72) Inventors: Glen Pomorski, Park Ridge, IL (US); William Cady, Chicago, IL (US); Steven M. Poklop, Palatine, IL (US); Rajasi Shukre, Wheeling, IL (US); Carl J. Stevens, Deerfield, IL (US); Kathryn R. Bjorkman Marrou, Mount Prospect, IL (US); Matthew R. Zuraski, Schaumburg, IL (US); Sara E. Horton, Hanover Park, IL (US)

(21) Appl. No.: 18/761,599

(22) Filed: Jul. 2, 2024

Related U.S. Application Data
(60) Provisional application No. 63/584,609, filed on Sep. 22, 2023.

(51) Int. Cl. B01D 53/08

(52) U.S. Cl. CPC B01D 53/08; B01D 2259/40003; B01D 2259/4009

(57) ABSTRACT

Processes and apparatuses for adsorbing a species from a feed stream and regenerating adsorbent. A species from a feed stream is adsorbed in an adsorption zone with an adsorbent to provide a species lean stream and a species enriched adsorbent. In a regeneration zone disposed above the adsorption zone, the species from the species enriched adsorbent is desorbed with a regeneration gas to provide a regenerated adsorbent and a spent regeneration gas. A portion of the species lean stream is used as the regeneration gas.

### CROSS-REFERENCES TO RELATED APPLICATIONS

This application claims the benefit of U.S. Provisional Patent Application Ser. No. 63/584,609 filed on Sep. 22, 2023, the entire disclosure of which is incorporated herein by way of reference.

### FIELD OF THE INVENTION

This invention relates generally to processes and apparatuses for adsorbing a species from a feed stream and regenerating adsorbent.

### BACKGROUND OF THE INVENTION

Adsorption processes are used for separation of a species from a feed stream across a broad set of arts including refining, petrochemical processing, natural gas processing, and hydrogen processing. Temperature swing adsorption (TSA) is a known processing technique in which fixed beds of adsorbent are alternated between low and high temperatures. Selective adsorption of species from a feed stream occurs at low temperatures. The adsorbent chamber is then isolated and contacted with heated regenerant to raise the temperature and strip the species from the adsorbent to regenerate the adsorbent bed. The regenerated bed is then cooled prior to starting another cycle of adsorption.

Recently, in contrast to fixed beds of adsorbent, continuous flow, or moving bed, adsorption processes and devices have been provided. For example, U.S. Pat. No. 9,527,028 discloses continuous flow processes and devices for same.

While presumably effective for their intended purposes, it would be desirable to provide more effective and efficient ways of utilizing moving bed adsorption processes and devices for same.

### SUMMARY OF THE INVENTION

The present inventors have discovered new processes and devices for moving bed adsorption.

The present invention may be characterized, in at least one aspect, as providing a process for adsorbing a species from a feed stream by: adsorbing, in an adsorption zone with an adsorbent, a species from a feed stream to provide a species lean stream and a species enriched adsorbent; and, desorbing, in a regeneration zone disposed above the adsorption zone, the species from the species enriched adsorbent with a regeneration gas to provide a regenerated adsorbent and a spent regeneration gas, wherein regenerated adsorbent flows to the adsorption zone by gravity, wherein a flow of the feed stream is less than a minimum fluidization velocity in the adsorption zone, and wherein a flow of the regeneration gas is less than a minimum fluidization velocity in the regeneration zone.

The process may include lifting the species enriched adsorbent to the regeneration zone with a lifting gas. The lifting gas may be the spent regeneration gas.

The regeneration gas may include the species lean stream. The process may include heating the regeneration gas with the spent regeneration gas.

A flow of adsorbent through the adsorption zone may be countercurrent to a flow of the feed stream through the adsorption zone.

The feed stream may flow radially through the adsorption zone.

The adsorption zone may be a multi-stage adsorption zone. A first stage may be disposed below a second stage, and the feed stream may be introduced into the first stage and the regenerated adsorbent may be introduced into the second stage.

In a second aspect, the present invention may be broadly characterized as providing a continuous adsorbent regeneration process by: passing an adsorbent from a regeneration zone downward into an adsorption zone; introducing a feed stream into the adsorption zone, the feed stream comprising a species; adsorbing the species with the adsorbent by contacting the feed stream with the adsorbent under adsorbing conditions to provide a species lean stream and a species enriched adsorbent; lifting the species enriched adsorbent upward to the regeneration zone with a lifting gas; and, desorbing the species from the species enriched adsorbent with a regeneration gas to provide a regenerated adsorbent and a spent regeneration gas. The adsorbent is the regenerated adsorbent, and the regenerated adsorbent flows to the adsorption zone by gravity.

The process may include determining a level of adsorbent in the regeneration zone, the adsorption zone, or both, and controlling a flow of adsorbent based on one or more determined levels of adsorbent. Controlling the flow of adsorbent based on one or more determined levels of adsorbent may include operating a valve. The valve may be disposed between the regeneration zone and the adsorption zone. The valve may be disposed between the adsorption zone and a surge vessel, the surge vessel disposed below the adsorption zone.

A flow of adsorbent through the adsorption zone may be countercurrent to a flow of the feed stream through the adsorption zone.

The feed stream may flow radially through the adsorption zone.

The lifting gas may include the spent regeneration gas.

The regeneration gas may include the species lean stream.

In another aspect, the present invention may be broadly characterized as providing a vessel for regenerating adsorbent with: a regeneration zone having an inlet for a species enriched adsorbent, an outlet for regenerated adsorbent, an inlet for a regeneration gas, and an outlet for a spent regeneration gas, wherein the inlet for a species enriched adsorbent is at a height above a position of the outlet for regenerated adsorbent; an adsorption zone having an inlet for the regenerated adsorbent, an outlet for the species enriched adsorbent, an inlet for a feed stream, and an outlet for a species lean stream; a transfer pipe configured to allow the regenerated adsorbent to flow from the regeneration zone to the adsorption zone; and, a lifting line configured to lift, with a lift gas, the species enriched adsorbent upward to the regeneration zone.

The vessel may further include a line configured to provide a portion of the species lean stream as the regeneration gas.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

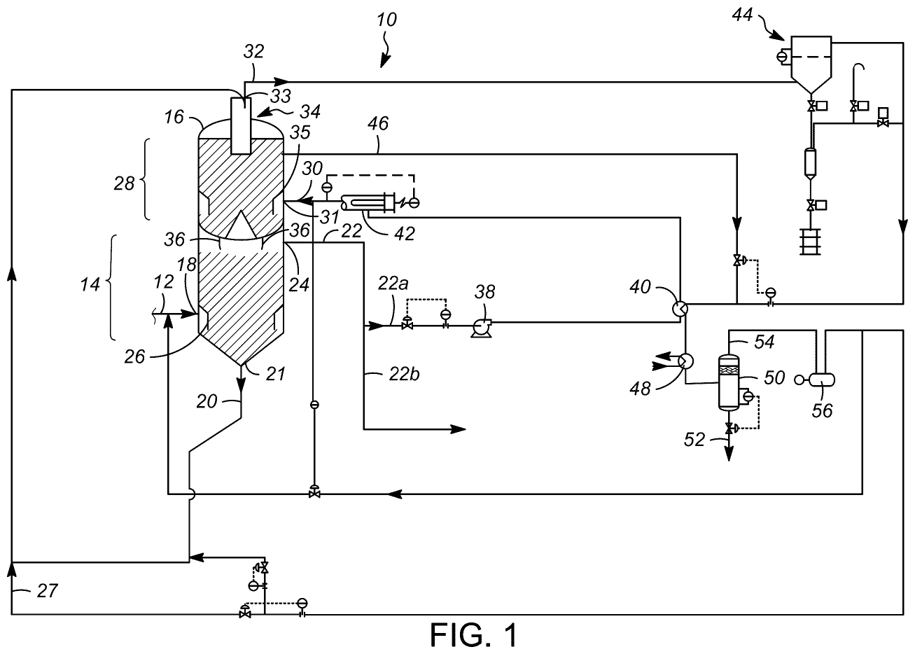

FIG. 1 shows a schematic process flow diagram according to one or more aspects of the present invention;

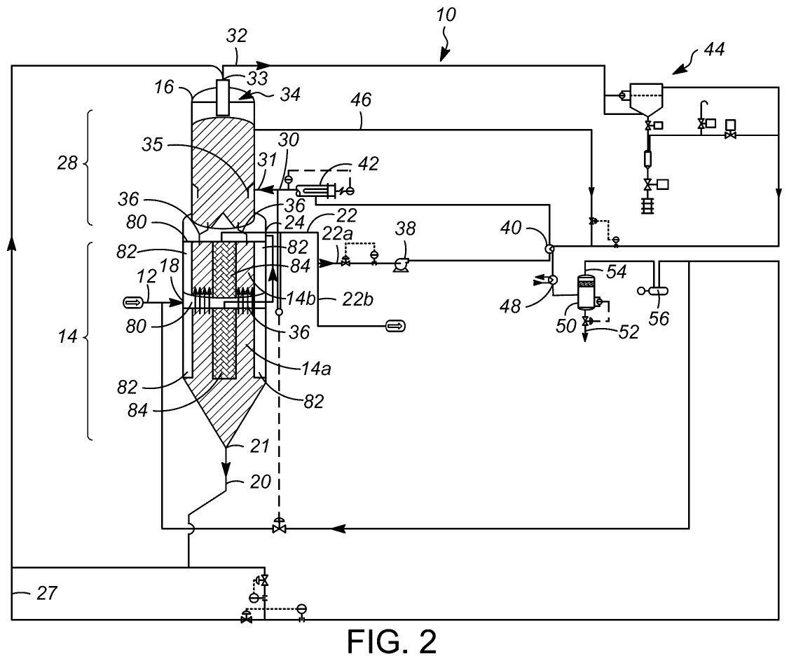

FIG. 2 shows a schematic process flow diagram according to one or more aspects of the present invention;

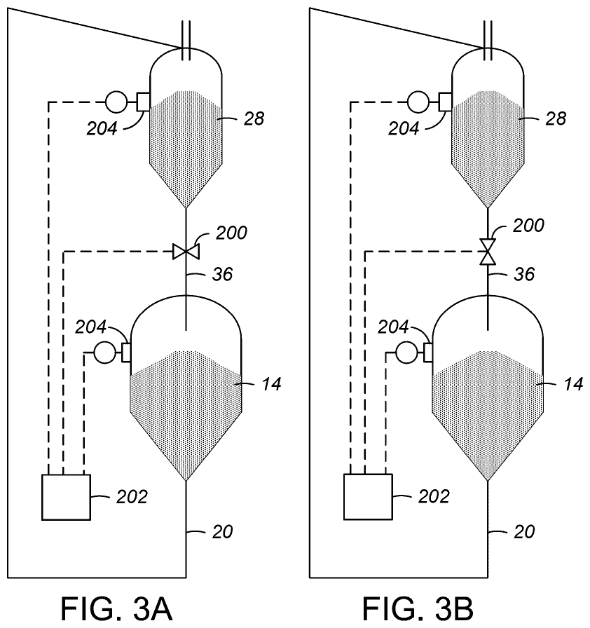

FIG. 3A shows a schematic diagram showing a valve in a closed position according to one or more aspects of the present invention;

FIG. 3B shows a schematic diagram showing a valve in an open position according to one or more aspects of the present invention;

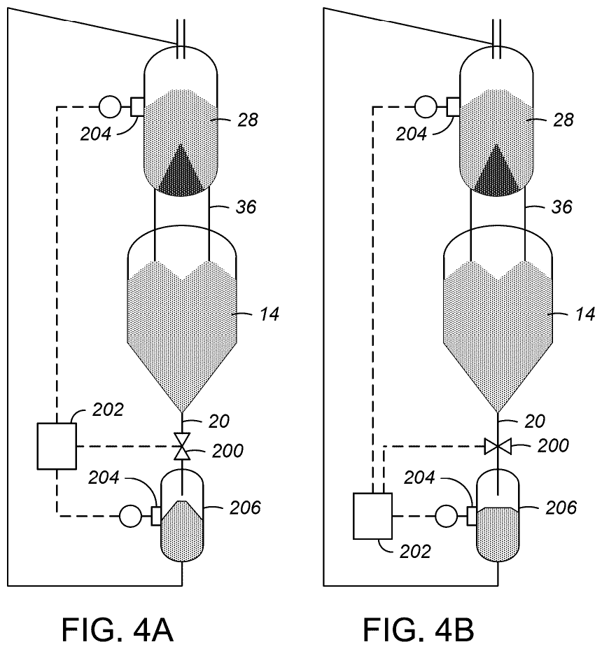

FIG. 4A shows a schematic diagram showing a valve in an open position according to one or more aspects of the present invention; and,

FIG. 4B shows a schematic diagram showing a valve in a closed position according to one or more aspects of the present invention.

### DETAILED DESCRIPTION OF THE INVENTION

As mentioned above, processes and apparatuses for moving bed adsorption have been invented. In various embodiments the adsorber is a bottom zone or vessel. Additionally, unlike prior “closed loop” processes, the present processes use an “open loop” regeneration which uses a portion of the product as the regeneration gas. This allows for a large concentration swing in addition to the temperature swing. This, in turn, allows for less regeneration gas and better regeneration of the adsorbent. Additionally, the present processes and devices do not require a dedicated cooling zone. Moreover, the regenerator and elutriation zone may be combined in one vessel which reduces the amount of circulating gas required by using regeneration gas as elutriation gas to remove fines. Additionally, by using the spent regeneration gas to heat the regeneration gas, operating costs may be reduced.

With these general principles in mind, one or more embodiments of the present invention will be described with the understanding that the following description is not intended to be limiting.

Turning to FIG. 1, an exemplary apparatus 10 for adsorbing a species from a feed stream 12 is shown. Example feed streams including hydrocarbon streams, inert gas streams, aqueous streams, and others. The adsorbed species can include more than one targeted species. Example species to be removed include HCl, water, organic chlorides, and organic fluorides, CO₂, NO_{X}, SO_{X}, H₂S, or mercury, to name a few.

The feed stream 12 is passed into an adsorption zone 14 of a vessel 16 via an inlet 18. The feed stream 12 may be conditioned (not shown) upstream of the adsorption zone 14. Example conditioning includes heating and/or cooling the feed stream 12. The adsorption zone 14 includes a moving bed of adsorbent for contacting the feed stream to selectively adsorb the adsorbed species. Example adsorbents include a molecular sieve, alumina, silica gel, activated carbon, or a zeolite. The zeolite adsorbent may be one or more of types A, D, L, R, S, T, X, Y, ZSM, mordenite, or clinoptilolite. The zeolite adsorbent is one or more of types 4A, 5A, 13X, NaY, or ZSM-5.

Adsorbent particles may be spheroidal, having a diameter of from about 1/16^{th} to about ⅛^{th} inch (1.5-3.1 mm), though they may be as large as ⅛^{th} inch (6.35 mm).

In the adsorption zone 14, the adsorbed species from the feed stream 12 is selectively adsorbed onto the adsorbent in the moving bed at an adsorbing temperature. Thus, the sorbent is enriched with the species to provide species-rich sorbent 20, and the species from the feed stream 12 is depleted to provide a species-lean product stream 22. The species-lean product stream 22 may be withdrawn or recovered from the vessel 16, via an outlet 24. The further processing of the species-lean product stream 22 is discussed below.

In the vessel 16 of FIG. 1, an annular baffle 26 is provided proximate the inlet 18 to distribute the feed stream 12. The design also minimizes pressure drop which is important to avoid fluidization of the adsorbent within the adsorption zone 14. Accordingly, a flow of the feed stream 12 through the adsorption zone 14 is less than a minimum fluidization velocity in the adsorption zone 14.

As would be appreciated, the minimum fluidization velocity in the adsorption zone 14 may be determined with

$$( {ρ}_{p} - {ρ}_{f} ) g = 150 \frac{{μ}_{f} {V}_{mf} ( 1 - {ε}_{mf} )}{{ϕ}_{s}^{2} {D}_{p}^{2} {ε}_{mf}^{3}} + 1.75 \frac{{ρ}_{f} {V}_{mf}^{2}}{{ϕ}_{s} {D}_{p} {ε}_{mf}^{3}} , \qquad [ EQ . 1 ]$$

wherein V_{mf}=minimum fluidization velocity;
Dₚ=diameter of particle;
E_{mf}=bed porosity;
ρp=density of the solid particle;
ρf=density of the fluid;
g=acceleration due to gravity; and,
φ=particle sphericity.

It is also contemplated that the minimum fluidization velocity could be determined with the designated fluid (at intended composition and conditions) and distributing the designated fluid upflow through a fixed bed of the intended material (adsorbent). When the bed starts to fluidize (move/lift), the flowrate of fluid and the known open area of the distributor can be used to calculate the velocity of fluid through the bed. This is the minimum fluidization velocity.

In the depicted configuration, the inlet 18 for the feed stream 12 is located at a lower position, or below, than the outlet 24 for the species-lean product stream 22. Accordingly, the flow in the adsorption zone 14 will be, generally, upwards. At the same time, the flow of adsorbent though the adsorption zone 14 will generally be downward (due to gravity). Thus, the flow is countercurrent to the flow of adsorbent in the adsorption zone 14. As will be described herein, other configurations are contemplated.

The species-rich sorbent 20 is recovered from the vessel 16, at an outlet 21, and, with a fluidization gas 27, is carried to an upper portion of the vessel 16 having a regeneration zone 28. The regeneration zone 28 is disposed above the adsorption zone 14.

A regeneration gas 30 is introduced, via an inlet 31, into the regeneration zone 28 at a regenerating temperature. The regenerating temperature is greater than the adsorbing temperature in the adsorption zone 14. Within the regeneration zone 28, the species-rich sorbent 20 is contacted with the regeneration gas 30 to strip the adsorbed species from the adsorbent, providing a regenerated adsorbent, and a spent regeneration gas 32 with the desorbed species. Before being recovered from the vessel 16, via an outlet 33, the spent regeneration gas 32 may be used to remove fines in an elutriation zone 34.

The regenerated adsorbent will fall (due to gravity), through transfer pipes 36, to the adsorption zone 14 to, once again, be used to selectively adsorb the adsorbed species form the feed stream 12.

As shown in FIG. 1, according to one of more embodiments of the present invention, a first portion 22a of the species-lean product stream 22 may be used as the regeneration gas 30, while a second portion 22b of the species-lean product stream 22 is recovered as a product stream and processed as desired. Using a portion of the species-lean product stream 22 as the regeneration gas 30 allows for a large concentration swing in addition to a temperature swing which results in less regeneration gas and greater capacity use of the adsorbent.

As shown in FIG. 1, for example, the first portion 22a of the species-lean product stream 22 may pass to a blower 38, a heat exchanger 40, and a heater 42 to reach a temperature between 150-350° C. before passing to the regeneration zone 28 as the regeneration gas 30. The regeneration gas 30 enters the regeneration zone 28, via the inlet 31, with an annular baffle 35 again provided to distribute gas throughout the bed to ensure uniform contact between the adsorbent and the regeneration gas 30 in order to remove the contaminant from the solid phase. Additionally, the baffle 35 also minimizes pressure drop which reduces fluidization of the adsorbent within the regeneration zone 28. Accordingly, a flow of the regeneration gas 30 through the regeneration zone 28 is less than a minimum fluidization velocity in the regeneration zone 28. The minimum fluidization velocity in the regeneration zone 28 may be determined as discussed above.

From the vessel 16, the spent regeneration gas 32 may be passed to a separation zone 44 to remove particles. The spent regeneration gas 32 may then be combined with a bypass spent regeneration gas 46 (which does not pass through the elutriation zone 34) and then passed to the heat exchanger 40 to heat the first portion 22a of the species-lean product stream 22. The amount of spent regeneration gas 32 exiting via the elutriation zone 34 (compared with the amount of the bypass spent regeneration gas 46) may be controlled to ensure the removal of particles which are too small for use in the process.

From the heat exchanger 40, the spent regeneration gas 32 may pass to a regeneration gas condenser 48, where at least a portion of the desorbed species is cooled and at least a portion of the desorbed species is condensed from the spent regeneration gas 32. The spent regeneration gas 32 may then be passed to a separator 50 for separating the condensed desorbed species from the spent regeneration gas 32. The separator 50 may include a coalescer or be a knock out vessel or other such device. A wastewater stream 52, including the desorbed species, may be recovered and processed as is known in the art. A separator vent gas 54 comprising may be passed to blower 56 and then used as the lift gas 27 and/or combined with the feed stream 12.

Turning to FIG. 2, another embodiment of the present invention is shown in which the same reference numbers are used for identical features.

In FIG. 2, the feed stream 12 flows radially through the adsorption zone 14, and the adsorption zone 14 has two stages 14a, 14b.

In particular, from the inlet 18, the feed stream 12 in the first stage 14a flows over a plate 80, or coverdeck, and downward through scallops 82. In the depicted embodiment, the fluid then flows inward, through porous members into the adsorbent bed where the species is adsorbed onto the adsorbent. The fluid continues to a center pipe 84 where it can flow upward and out of the first stage 14a and to the second stage 14b. In the second stage 14b, the flow is the same, and the species-lean product stream 22 is recovered again from the outlet 24. In FIG. 2, transfer pipes 36 are also used to allow for adsorbent to move from the second stage 14b to the first stage 14a. It is also contemplated that the flow of fluid is radially outward.

The multi-stage radial flow (depicted in FIG. 2 as two stage) maximizes the use of the adsorbent by separating the adsorption into multiple beds. The top bed (second stage 14b) utilizes the freshest adsorbent from the regeneration zone 28 thereby achieving the species-lean product stream 22 with the lowest contaminant. The spent adsorbent from the top bed (second stage 14b) has a portion of un-used bed which is proportional to the speed of the kinetics associated with loading the target contaminant on the selected adsorbent. Utilizing multiple beds below this top bed loads more sorbent onto the unused section of the adsorbent, pushing the loading front and thereby decreasing the weight of unused bed.

Turn to FIGS. 3A, 3B, 4A, and 4B, the present invention also contemplates controlling a flow of adsorbent based determined levels of adsorbent. In these FIGS., identical reference numbers are used for the same features.

In FIGS. 3A and 3B, a valve 200 is disposed on a transfer pipe 36 between the regeneration zone 28 and the adsorption zone 14. The valve 200 is in communication with a controller 202. The controller 202 is also in communication with level indicators 204, or sensors, associated with each of the regeneration zone and the adsorption zone.

The controller 202 or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

In FIG. 3A, a level indicator 204 associated with the regeneration zone 28 may be used to determine solids circulation rate. As the valve 200 closes, the level of adsorbent in the regeneration zone 28 increases providing volume/mass of adsorbent circulated in the time period the valve 200 is closed. The adsorption zone 14 no longer operates solids full when valve 200 is closed. The fluctuating level provides an indication of overall adsorbent inventory. Example measurements devices/technologies include nuclear, vibration, capacitance, radar, and guided wave radar instruments, to name a few.

In FIG. 3B, the valve 200 is opened, and the adsorbent flows to the adsorption zone 14 via the transfer pipes 36.

In FIG. 4A, a surge vessel 206 is provided which receives the species-rich sorbent 20. Additionally, the surge vessel 206 and the regeneration zone 28 include the level indicators 204, and the valve 200 is between the adsorption zone 14 and the surge vessel 206.

When valve 200 is open the surge vessel 206 is filled with adsorbent deposited from the adsorption zone 14 and the regeneration zone 28. The adsorption zone 14 fills with adsorbent and the level indicator 204 on the regeneration zone 28 gives indication of total adsorbent inventory. The level may cycle with the valve sequence but overall, the trend of the regeneration zone 28 will determine when adsorbent needs to be added.

Turning to FIG. 4B, as valve 200 is closed, the level in the regeneration zone 28 will increase slowly. The adsorption zone 14 will remain full. As the valve 200 closes, the level will start to drop in the surge vessel 206. The level is detected by the level indicator 204 on the surge vessel 206 and may be converted into a volume lost over the time period the valve 200 is closed. This volume can then be converted to a mass of solids circulation using the average bed density. A surge volume always remains in the surge vessel 206 to maintain a constant flow to the lift.

These processes allow the circulation rate of the processes and devices to be determined.

### Specific Embodiments

While the following is described in conjunction with specific embodiments, it will be understood that this description is intended to illustrate and not limit the scope of the preceding description and the appended claims.

A first embodiment of the invention is a process for adsorbing a species from a feed stream, the process comprising adsorbing, in an adsorption zone with an adsorbent, a species from a feed stream to provide a species lean stream and a species enriched adsorbent; and, desorbing, in a regeneration zone disposed above the adsorption zone, the species from the species enriched adsorbent with a regeneration gas to provide a regenerated adsorbent and a spent regeneration gas, wherein the regenerated adsorbent flows to the adsorption zone by gravity, wherein a flow of the feed stream is less than a minimum fluidization velocity in the adsorption zone, and wherein a flow of the regeneration gas is less than a minimum fluidization velocity in the regeneration zone. An embodiment of the invention is one, any or all of prior embodiments in this paragraph up through the first embodiment in this paragraph, further comprising lifting the species enriched adsorbent to the regeneration zone with a lifting gas. An embodiment of the invention is one, any or all of prior embodiments in this paragraph up through the first embodiment in this paragraph, wherein the lifting gas comprises the spent regeneration gas. An embodiment of the invention is one, any or all of prior embodiments in this paragraph up through the first embodiment in this paragraph, wherein the regeneration gas comprises the species lean stream. An embodiment of the invention is one, any or all of prior embodiments in this paragraph up through the first embodiment in this paragraph, further comprising heating the regeneration gas with the spent regeneration gas. An embodiment of the invention is one, any or all of prior embodiments in this paragraph up through the first embodiment in this paragraph, wherein a flow of adsorbent through the adsorption zone is countercurrent to a flow of the feed stream through the adsorption zone. An embodiment of the invention is one, any or all of prior embodiments in this paragraph up through the first embodiment in this paragraph, wherein the feed stream flows radially through the adsorption zone. An embodiment of the invention is one, any or all of prior embodiments in this paragraph up through the first embodiment in this paragraph, wherein the adsorption zone is a multi-stage adsorption zone. An embodiment of the invention is one, any or all of prior embodiments in this paragraph up through the first embodiment in this paragraph, wherein a first stage is disposed below a second stage, and wherein the feed stream is introduced into the first stage and wherein regenerated adsorbent is introduced into the second stage.

A second embodiment of the invention is a continuous regeneration process, the process comprising passing an adsorbent from a regeneration zone downward into an adsorption zone; introducing a feed stream into the adsorption zone, the feed stream comprising a species; adsorbing the species with the adsorbent by contacting the feed stream with the adsorbent under adsorbing conditions to provide a species lean stream and a species enriched adsorbent; lifting the species enriched adsorbent upward to the regeneration zone with a lifting gas; and, desorbing the species from the species enriched adsorbent with a regeneration gas to provide a regenerated adsorbent and a spent regeneration gas, wherein the adsorbent comprises the regenerated adsorbent, and, wherein the regenerated adsorbent flows to the adsorption zone by gravity. An embodiment of the invention is one, any or all of prior embodiments in this paragraph up through the second embodiment in this paragraph, further comprising determining a level of adsorbent in the regeneration zone, the adsorption zone, or both; and controlling a flow of adsorbent based on one or more determined levels of adsorbent. An embodiment of the invention is one, any or all of prior embodiments in this paragraph up through the second embodiment in this paragraph, wherein controlling the flow of adsorbent based on one or more determined levels of adsorbent comprises operating a valve. An embodiment of the invention is one, any or all of prior embodiments in this paragraph up through the second embodiment in this paragraph, wherein the valve is disposed between the regeneration zone and the adsorption zone. An embodiment of the invention is one, any or all of prior embodiments in this paragraph up through the second embodiment in this paragraph, wherein the valve is disposed between the adsorption zone and a surge vessel, the surge vessel disposed below the adsorption zone. An embodiment of the invention is one, any or all of prior embodiments in this paragraph up through the second embodiment in this paragraph, wherein a flow of adsorbent through the adsorption zone is countercurrent to a flow of the feed stream through the adsorption zone. An embodiment of the invention is one, any or all of prior embodiments in this paragraph up through the second embodiment in this paragraph, wherein the feed stream flows radially through the adsorption zone. An embodiment of the invention is one, any or all of prior embodiments in this paragraph up through the second embodiment in this paragraph, wherein the lifting gas comprises the spent regeneration gas. An embodiment of the invention is one, any or all of prior embodiments in this paragraph up through the second embodiment in this paragraph, wherein the regeneration gas comprises the species lean stream.

A third embodiment of the invention is a vessel for regenerating adsorbent, the vessel comprising a regeneration zone having an inlet for a species enriched adsorbent, an outlet for regenerated adsorbent, an inlet for a regeneration gas, and an outlet for a spent regeneration gas, wherein the inlet for a species enriched adsorbent is at a height above a position of the outlet for regenerated adsorbent, an adsorption zone having an inlet for the regenerated adsorbent, an outlet for the species enriched adsorbent, an inlet for a feed stream, and an outlet for a species lean stream, a transfer pipe configured to allow the regenerated adsorbent to flow from the regeneration zone to the adsorption zone, and a lifting line configured to lift, with a lift gas, the species enriched adsorbent upward to the regeneration zone. An embodiment of the invention is one, any or all of prior embodiments in this paragraph up through the third embodiment in this paragraph, further comprising a line configured to provide a portion of the species lean stream as the regeneration gas.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for adsorbing a species from a feed stream, the process comprising:
adsorbing, in an adsorption zone with an adsorbent, a species from a feed stream to provide a species lean stream and a species enriched adsorbent; and,
desorbing, in a regeneration zone disposed above the adsorption zone, the species from the species enriched adsorbent with a regeneration gas to provide a regenerated adsorbent and a spent regeneration gas,
wherein the regenerated adsorbent flows to the adsorption zone by gravity,
wherein a flow of the feed stream is less than a minimum fluidization velocity in the adsorption zone, and
wherein a flow of the regeneration gas is less than a minimum fluidization velocity in the regeneration zone.

2. The process of claim 1, further comprising:
lifting the species enriched adsorbent to the regeneration zone with a lifting gas.

3. The process of claim 2, wherein the lifting gas comprises the spent regeneration gas.

4. The process of claim 1, wherein the regeneration gas comprises the species lean stream.

5. The process of claim 4, further comprising:
heating the regeneration gas with the spent regeneration gas.

6. The process of claim 1, wherein a flow of adsorbent through the adsorption zone is countercurrent to a flow of the feed stream through the adsorption zone.

7. The process of claim 1, wherein the feed stream flows radially through the adsorption zone.

8. The process of claim 1, wherein the adsorption zone is a multi-stage adsorption zone.

9. The process of claim 8, wherein a first stage is disposed below a second stage, and wherein the feed stream is introduced into the first stage and wherein regenerated adsorbent is introduced into the second stage.

10. A continuous adsorbent regeneration process, the process comprising:
passing an adsorbent from a regeneration zone downward into an adsorption zone;
introducing a feed stream into the adsorption zone, the feed stream comprising a species;
adsorbing the species with the adsorbent by contacting the feed stream with the adsorbent under adsorbing conditions to provide a species lean stream and a species enriched adsorbent;
lifting the species enriched adsorbent upward to the regeneration zone with a lifting gas; and,
desorbing the species from the species enriched adsorbent with a regeneration gas to provide a regenerated adsorbent and a spent regeneration gas,
wherein the adsorbent comprises the regenerated adsorbent, and,
wherein the regenerated adsorbent flows to the adsorption zone by gravity.

11. The process of claim 10, further comprising:
determining a level of adsorbent in the regeneration zone, the adsorption zone, or both; and
controlling a flow of adsorbent based on one or more determined levels of adsorbent.

12. The process of claim 11, wherein controlling the flow of adsorbent based on one or more determined levels of adsorbent comprises:
operating a valve.

13. The process of claim 12, wherein the valve is disposed between the regeneration zone and the adsorption zone.

14. The process of claim 12, wherein the valve is disposed between the adsorption zone and a surge vessel, the surge vessel disposed below the adsorption zone.

15. The process of claim 10, wherein a flow of adsorbent through the adsorption zone is countercurrent to a flow of the feed stream through the adsorption zone.

16. The process of claim 10, wherein the feed stream flows radially through the adsorption zone.

17. The process of claim 10, wherein the lifting gas comprises the spent regeneration gas.

18. The process of claim 10, wherein the regeneration gas comprises the species lean stream.

19. A vessel for regenerating adsorbent, the vessel comprising:
a regeneration zone having an inlet for a species enriched adsorbent, an outlet for regenerated adsorbent, an inlet for a regeneration gas, and an outlet for a spent regeneration gas, wherein the inlet for a species enriched adsorbent is at a height above a position of the outlet for regenerated adsorbent;
an adsorption zone having an inlet for the regenerated adsorbent, an outlet for the species enriched adsorbent, an inlet for a feed stream, and an outlet for a species lean stream;
a transfer pipe configured to allow the regenerated adsorbent to flow from the regeneration zone to the adsorption zone; and,
a lifting line configured to lift, with a lift gas, the species enriched adsorbent upward to the regeneration zone.

20. The vessel of claim 19, further comprising a line configured to provide a portion of the species lean stream as the regeneration gas.
